(19) United States
(12) Patent Application Publication
(10) Pub. No.: US 2003/0061900 A1
(43) Pub. Date: Apr. 3, 2003

(54) Bicycle crank pedal insert

(76) Inventor: Garrett Andrew Smith, San Luis Obispo, CA (US)

Correspondence Address: Garrett A. Smith, 645 Tank Farm Road #G, San Luis Obispo, CA, 93401, US

(21) Appl. No.: 10/236,162

(22) Filed: Sep. 5, 2002

Related U.S. Application Data
(60) Provisional application No. 60/326,102, filed on Sep. 28, 2001.

(51) Int. Cl. G05G 1/14

(52) U.S. Cl. 74/594.1

(57) ABSTRACT

A bicycle crank assembly comprised of a crank arm and a pedal connected to the crank arm. The crank arm has a pedal-connecting portion through which a transverse hole is located. Contained within the transverse hole is an insert, which is made from a harder material than that of the crank arm. The insert has an inner threaded bore and a support surface located at the front end of the threaded bore. A pedal is attached to the insert such that a threaded portion of the pedal is screwed into the threaded bore of the insert and a flange portion of the pedal abuts against the insert support surface.

### TECHNICAL FIELD

The present invention pertains to a bicycle crank assembly and a bicycle crank arm, and more specifically to a crank insert for use in a bicycle and to features of such an insert, which improve the load-bearing capacity of the pedal-crank interface.

### BACKGROUND OF THE INVENTION

Mountain Bike riding is a relatively young sport. It is a sport based on a bicycle rider's ability to traverse difficult off-road terrain. Mountain bike pedals tend to support most of the rider's body weight since a great deal of body articulation, which requires a fairly upright position, is necessary to negotiate such terrain. This fact, combined with impact and acceleration loads, results in tremendous forces applied to the pedals. These forces are transmitted to the bicycle frame by means of a crank, which typically has a bicycle frame portion and a pedal portion. The frame portion of the crank typically has a hole to accept a bearing mounted spindle extending from the bicycle frame. The interface between the frame spindle and the frame portion of the crank is typically such that there is no relative motion between the two. The pedal portion typically has a threaded hole to accept a threaded pedal spindle. The threaded pedal spindle is typically of a harder material than the crank. Two separate features of the pedal-crank interface support the forces applied to the pedals. The first pedal-crank interface feature is the mate between female and male threads on the crank and pedal spindle, respectively. The second pedal-crank interface feature is the normal contact between the flanged portion of the pedal spindle and the outer face of the crank.

It has been discovered, through experience, that the loads induced on the normal contact between the flanged portion of the pedal spindle and the outer face of the crank are great enough to deform the crank material beyond its elastic limit. The resulting permanent deformation to the crank face produces in a gap between the flanged portion of the pedal spindle and the outer face of the crank that diminishes or eliminates the effective load carrying capability of this second pedal-crank interface feature. Therefore, the mating threads of the pedal spindle and crank become responsible for supporting all pedal induced loads. This loading scenario can quickly result in damage to the pedal-crank interface threads because the pedal can now “rock” inside the mating crank threads.

Thread damage may also occur due to over-tightening the pedal when attaching the pedal to the crank. The crank material, being typically of a softer material than the pedal spindle, looses its thread integrity before the pedal spindle. Over-tightening the pedal-crank interface may also result in damage to the crank surface if the pedal spindle does not contain a sufficiently smooth and large bearing flange to effectively contact the outer face of the crank, as is the case with most inexpensive bicycle pedals. This is due to the fact that the flat portions of the flange (sized to accept a standard pedal wrench) may act as a cutter and substantially damage the crank.

U.S. Pat. No. 4,446,753 to Nagano discloses a crank arm for a bicycle. In order to change the effective length thereof, the crank arm has at its pedal-mounting portion a hole to receive inserts with eccentric mounting bores for a pedal shaft. The inserts are fixed in the hole by splines or set-screws. However, these inserts do not improve the connection between the pedal and the crank arm.

DE 4 342 891 shows a bicycle crank assembly with a crank arm and a pedal. The pedal is rotatably connected to the crank arm by a special interface designed to easily mount and unmount the pedal. The interface comprises an insert that is screwed into a transverse bore of the crank arm at the pedal-mounting portion thereof. The insert comprises a smooth central opening, which receives the end of a pedal axle. The crank assembly is not optimal with regard to pullout strength since it makes use of a simple axial stop provided on the pedal axle, which will lead to increased play at the interface such that the interface will be even weaker under repeated high loads.

It is thus the object of the present invention to provide a bicycle crank assembly where the pedal can support high loads without deformation or damage to the pedal-crank interface.

### BRIEF SUMMARY OF THE INVENTION

The present invention improves the pedal-crank interface by utilizing an insert of a harder material than the material of the crank arm. This insert is received in a transverse hole of the crank arm. A standard pedal can be mounted in a threaded bore of the insert and is supported at a support surface.

### BRIEF DESCRIPTION OF THE DRAWINGS

FIG. 1 is a perspective view of the crank arm, pedal, and insert assembly used in the preferred embodiment.

FIG. 2A is a side view of the crank arm, pedal, and insert assembly used in the preferred embodiment.

FIG. 2B is a bottom cross sectional view of the crank arm, pedal, and insert assembly used in the preferred embodiment.

FIG. 2C is a detailed view of FIG. 2B showing the crank arm, pedal, and insert assembly used in the preferred embodiment.

FIG. 3A is a side view of the crank arm used in the preferred embodiment.

FIG. 3B is a partial bottom cross sectional view of the pedal end of the crank arm used in the preferred embodiment.

FIG. 4A is a perspective view of the insert used in the preferred embodiment.

FIG. 4B is a front view of the insert used in the preferred embodiment.

FIG. 4C is a side cross sectional view of the insert used in the preferred embodiment.

FIG. 5A is a side view of the insert assembled into the crank arm for the preferred embodiment.

FIG. 5B is a partial bottom cross sectional view of the insert assembled in the crank arm for the preferred embodiment.

FIG. 6 is a perspective view of a typical pedal for use with a bicycle crank arm.

### DETAILED DESCRIPTION OF A PREFERRED EMBODIMENT

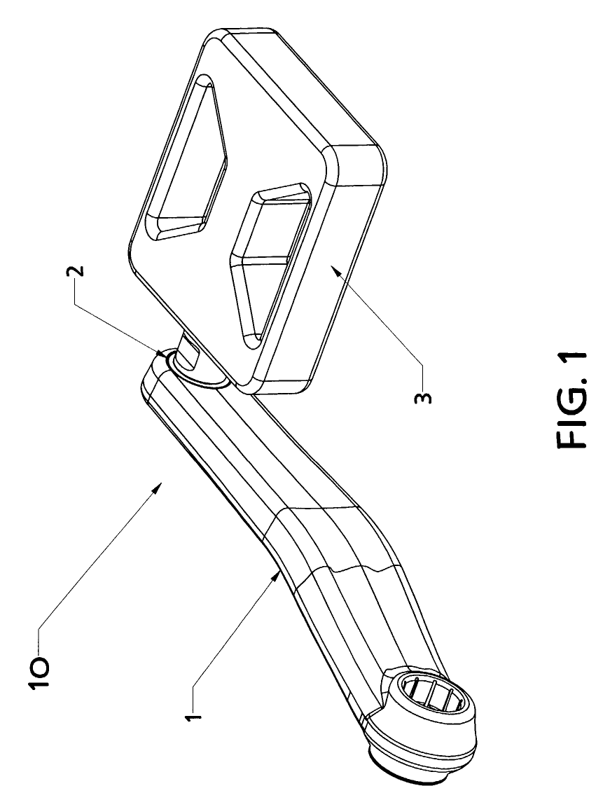

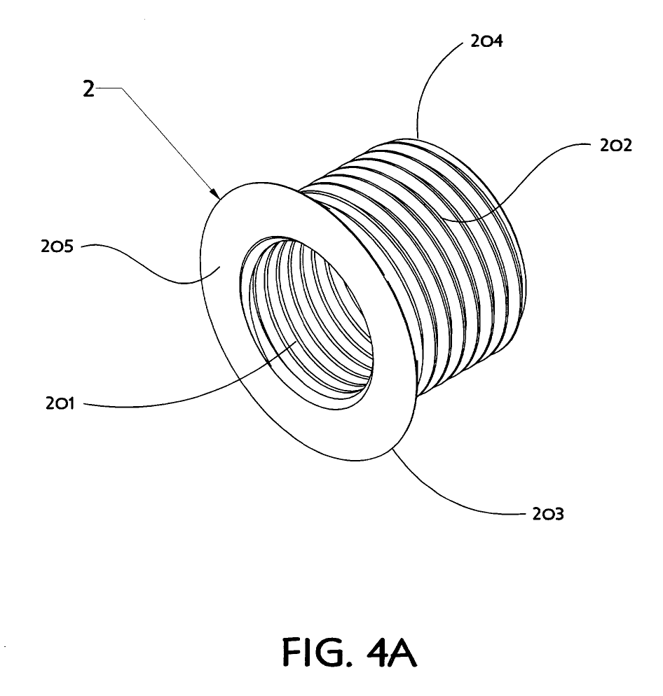

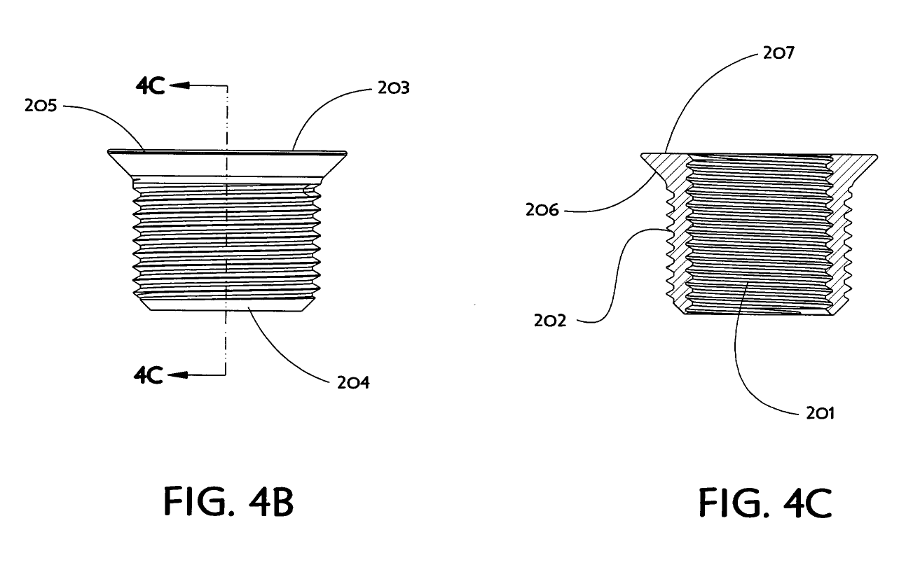

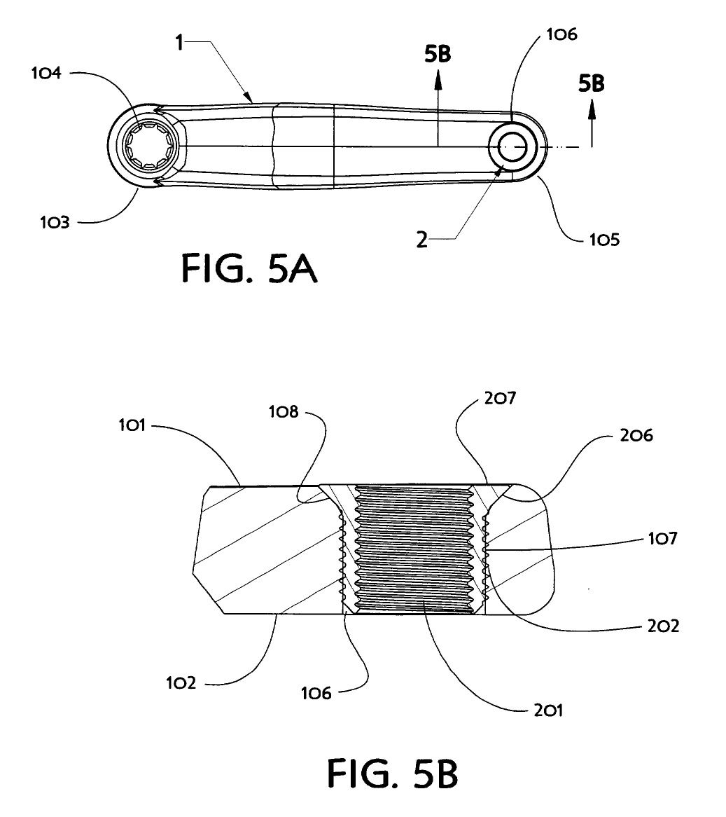

FIGS. 1-6 show a preferred embodiment of the invention.

As shown in FIG. 1, a bicycle crank assembly 10 comprises a crank arm 1, an insert 2 and a pedal 3.

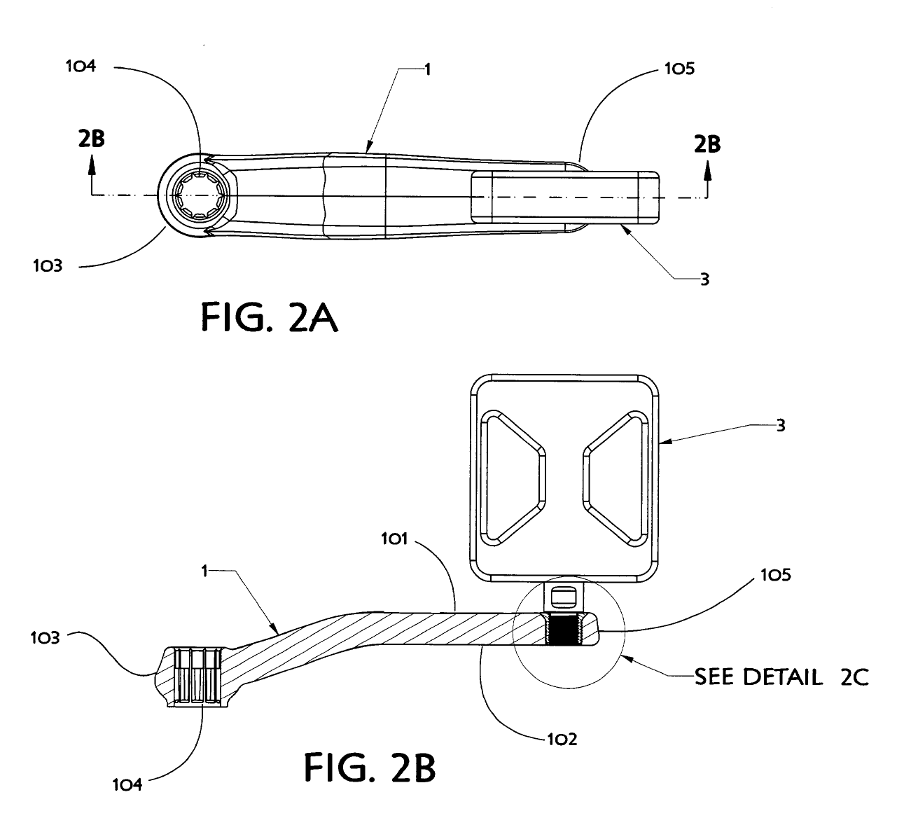

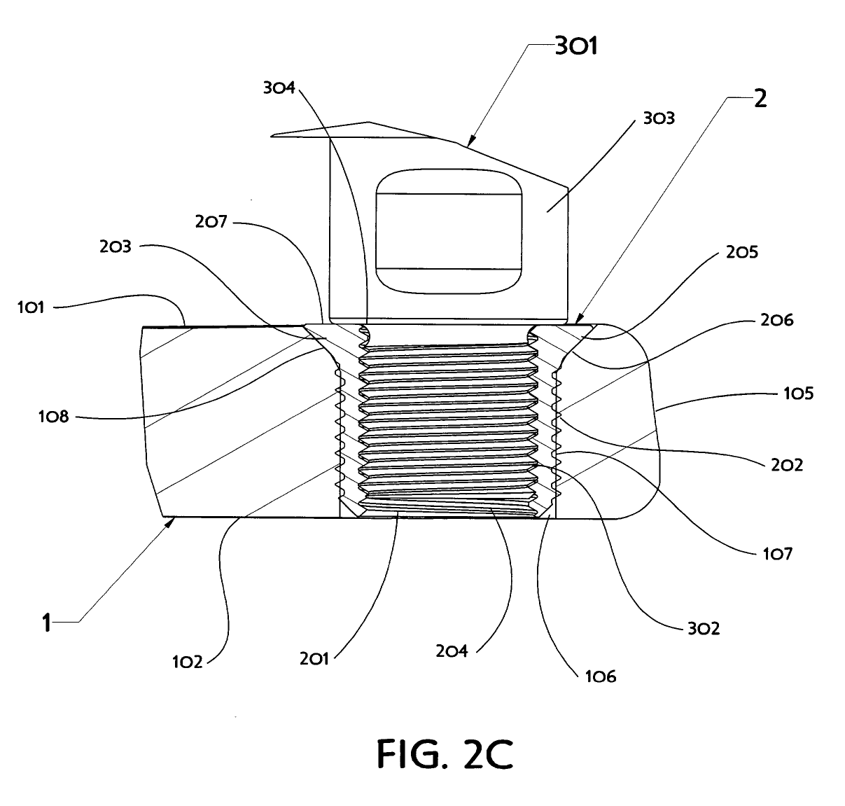

Crank arm 1, as shown in FIGS. 2A and 2B, has an outer surface 101, an inner surface 102, a bicycle frame portion 103 with a frame spindle hole 104, and a pedal portion 105 with a transverse insert hole 106. Crank arm 1 may be mounted on a bicycle frame using frame spindle hole 104 of bicycle frame portion 103 in a known manner.

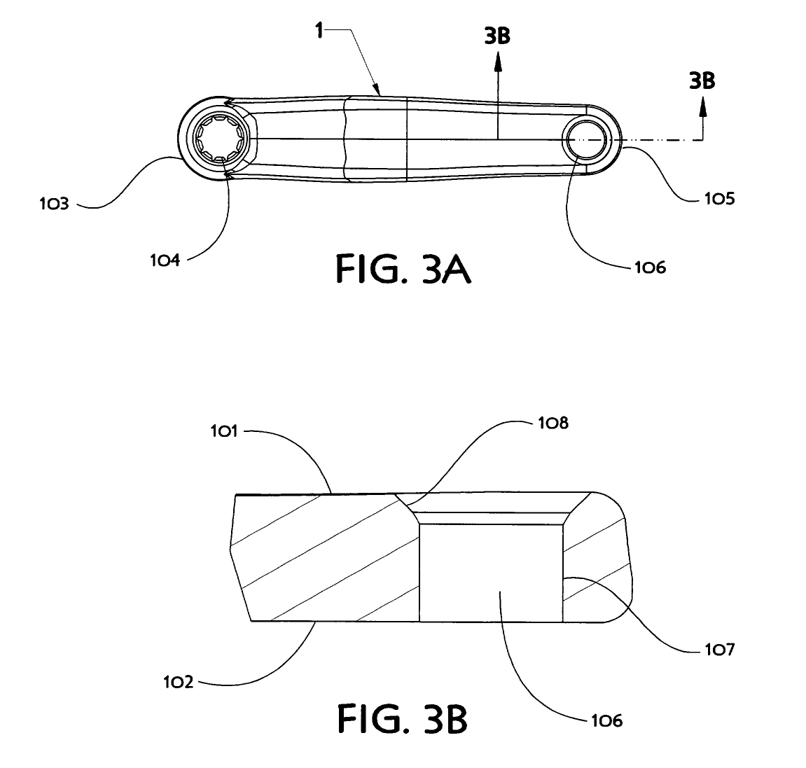

FIG. 3B shows insert hole 106 in more detail. Insert hole 106 has a first portion and a second portion. The first portion is cylindrical and is comprised of an inner cylindrical insert hole surface 107. The outer surface 101 and inner surface 102 of crank arm 1 are generally parallel and the insert hole 106 is bored normal to said inner surface 102 and outer surface 101 such that the insert hole 106 is transverse to the longitudinal crank arm direction. The second portion of insert hole 106 comprises a counter-bore with an inner surface 108, which extends from the insert hole surface 107 to the outer crank surface 101. In the preferred embodiment, as shown in FIG. 3B, the inner surface 108 forms an angle of less than 90 degrees with the outer crank surface 101.

FIG. 2C shows insert 2 contained in hole 106. Insert 2 has a first insert portion 204 and a second insert portion 203. First insert portion 204 is substantially cylindrical, while second insert portion 203 has a flange 205 about the circumference of the top end thereof.

Insert 2 has an inner thread set 201 and an outer thread set 202. The flange 205 has an inner flange surface 206 and an outer flange surface 207. Insert 2 is made of a harder material than crank arm 1. In the preferred embodiment, crank arm 1 is a solid and made of a lightweight metal alloy, such as aluminum. Insert 2 is made of hardened steel.

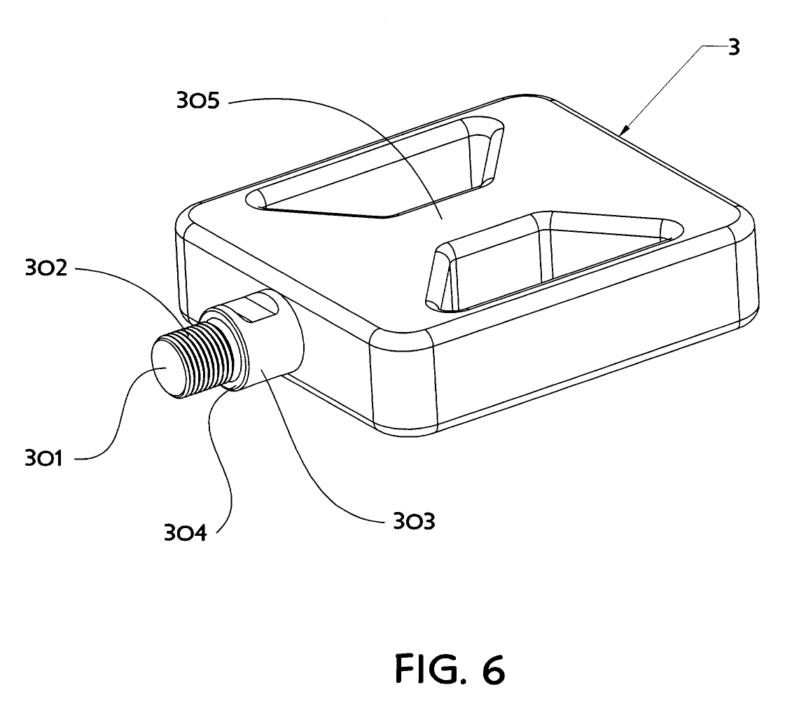

FIG. 6 shows the pedal 3 that has a pedal spindle 301, a set of pedal spindle threads 302, a pedal spindle flange 303, a pedal spindle flange surface 304 and a pedal platform 305.

As shown in FIG. 2C, the crank arm 1 and insert 2 are assembled such that the insert 2 is concentric with the insert hole 106. In the preferred embodiment the shape and size of the interface between the inner flange surface 206 and the counter bored crank surface 108 is optimized to support pedal induced loads and reactions in the most efficient manner. As shown in FIG. 2C, the insert 2 is received in hole 106 such that the inner flange surface 206 is supported by the material of crank arm 1.

The scope of the present invention is not limited in the specific geometry of the interface between inner flange surface 206 and crank surface 108 and many different geometries are possible.

The inner thread set 201 is sized to accept the pedal spindle threads 302 and mate such that the pedal spindle flange surface 304 is flush with the outer flange surface 207. In the preferred embodiment the diameter of the insert hole 106 is sized such that the outer thread set 202 will make an interference fit with the insert hole face 107 when they are assembled. This ensures the insert 2 is sufficiently attached to the crank arm 1 such that the insert is not easily removed from the crank arm and efficiently transfers load from the pedal spindle interface surfaces 302, 304 into the crank interface surfaces 107, 108. It should be noted, however, that the means of joining the insert 2 and crank arm 1 is not a limiting feature of the invention. The insert 2 may be pressed, bonded, or otherwise joined to the crank arm 1 by any means. Likewise, the outer thread set 202 of the insert 2 is not a critical aspect of the invention.

The preferred embodiment described above shows a significant improvement in the strength and life of the pedal-crank interface for crank arms made from lightweight materials, including metals, plastics, and composites. This is due to the fact that the insert is better suited to handle the concentrated pedal loads and transfer the loads to the crank arm in a dispersed and efficient manner.

1. A bicycle crank assembly comprising a crank arm and a pedal connected to said crank arm, where:
said crank arm comprises a transverse hole;
an insert is contained in said transverse hole, said insert being of a material harder than the material of said crank arm, said insert comprising an inner threaded bore and a support surface at a front end of said bore;
said pedal comprising a pedal spindle with a threaded portion and a flange portion, wherein said threaded portion is screwed into said inner threaded bore of said insert, and said flange portion abuts against said support surface.

2. A bicycle crank assembly according to claim 1, wherein said transverse hole comprises an inner thread, said insert comprises an outer thread, and said insert is screwed into said transverse hole.

3. A bicycle crank assembly according to claim 1, wherein said insert comprises a first portion and a second portion, said first portion being substantially cylindrical in shape, and said second portion being configured as a flange to said first portion, where said support surface is arranged at said second portion.

4. A bicycle crank assembly according to claim 3, wherein said second portion defines an inner flange surface and an outer flange surface, where said outer flange surface serves as said support surface, and where said transverse hole is shaped so as to receive said insert such that said inner flange surface is in contact with said crank arm.

5. A bicycle crank assembly according to claim 4, wherein said insert is completely received in said transverse hole, such that said outer flange surface is level with an outer surface of said crank arm.

6. A bicycle crank assembly according to claim 1, wherein said insert is completely received in said transverse hole, such that said support surface is level with an outer surface of said crank arm.

7. A bicycle crank assembly according to claim 1, wherein said support surface is of a larger diameter than said flange portion of said pedal spindle.

8. A bicycle crank arm comprising a bicycle frame portion and a pedal portion, said pedal portion comprising a transverse hole, where:
an insert is contained in said transverse hole, said insert being of a material harder than the material of said crank arm;
said insert comprising an inner threaded bore and a support surface at a front end of said bore, where said bore and said support surface are suited to mount a pedal spindle thereto.
